(19) United States
(12) Patent Application Publication
(10) Pub. No.: US 2014/0183173 A1
(43) Pub. Date: Jul. 3, 2014

(54) LASER WELDER

(71) Applicant: Hyundai Motor Company, Seoul (KR)

(72) Inventor: Jung Whan Yeum, Gunbuk-myeon (KR)

(73) Assignee: Hyundai Motor Company, Seoul (KR)

(21) Appl. No.: 14/064,852

(22) Filed: Oct. 28, 2013

(30) Foreign Application Priority Data
Dec. 28, 2012 (KR) 10-2012-0157511

(51) Int. Cl. B23K 26/067; B23K 26/24

(52) U.S. Cl. CPC B23K 26/0676; B23K 26/24
USPC 219/121.63

(57) ABSTRACT

A laser welder controls a focus and direction of a laser beam received from a laser oscillator through optical fiber and radiating the controlled laser beam. The laser welder may include a housing; a beam transmission unit expanding a beam size and simultaneously switching direction of the laser beam; a first radiation unit switching direction of the laser beam by reflecting part of the laser beam through a slot mirror and simultaneously reducing the beam size within the housing, thus forming a focus in a first welding unit through a first beam port; and a second radiation unit expanding and reducing a remainder of the laser beam received through the slot mirror of the first radiation unit and simultaneously switching a direction of the remainder, thus forming a focus in a second welding unit through a second beam port.

### CROSS-REFERENCE TO RELATED APPLICATION

The present application claims priority of Korean Patent Application Number 10-2012-0157511 filed on Dec. 28, 2012, the entire contents of which application is incorporated herein for all purposes by this reference.

### BACKGROUND OF INVENTION

1. Field of Invention

The present invention relates to a laser welder. More particularly, the present invention relates to a laser welder capable of performing multiple welding tasks by splitting a laser beam.

2. Description of Related Art

In general, welding is a process of integrally forming different metal members by joining the different metal members together by way of heating or melting. The welding is widely being used in various fields, such as shipbuilding, vehicles, and construction. There are a variety of welding methods, such as arc welding, gas welding, friction welding, and laser welding.

Particularly, a laser welder using a laser beam having excellent effects in terms of a reduced cost, factory automation, and improved quality is being used in the cutting, welding, and heat treatment of a metal material.

FIG. 1 is a schematic diagram of a conventional laser welder.

Referring to FIG. 1, the conventional laser welder 100 includes a rotation mirror 107 and a plurality of lenses 109 configured to receive a laser beam through optical fiber 101 from an additional laser oscillator, switch the direction of the laser beam or spread or reduce the size of the laser beam, and guide the laser beam having a reduced size to a beam port 105 formed at the bottom of a housing 103.

More particularly, the conventional laser welder 100 includes the lenses 109 for determining Z-side coordinates to which the laser beam is radiated and the rotation mirror 107 for determining X and Y coordinates. The conventional laser welder 100 sequentially welds a first welding unit W1 and a second welding unit W2 while changing a location to which the laser beam is radiated, that is, a focus by using the lenses 109 and the rotation mirror 107.

However, the conventional laser welder 100 sequentially performs a welding task by first welding the first welding unit W1, changing a location to which the laser beam is radiated, and then welding the second welding unit W2. Accordingly, the conventional laser welder 100 has a disadvantage in that the cycle time of a task process is increased.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a laser welder having an advantage of increasing use efficiency by splitting a laser beam through a slot mirror within a housing so that multiple welding tasks can be performed.

Various aspects of the present invention provide for a laser welder for controlling a focus and direction of a laser beam received from a laser oscillator through optical fiber and radiating the controlled laser beam, including a housing configured to have a first beam port and a second beam port formed in the lower part of the housing; a beam transmission unit configured to expand a beam size of the laser beam received through the optical fiber, simultaneously switch the direction of the laser beam, and send the switched laser beam within the housing; a first radiation unit configured to switch a direction of the laser beam by reflecting part of the laser beam received from the beam transmission unit through a slot mirror and simultaneously reduce the beam size of the laser beam within the housing, thus forming a focus in a first welding unit through the first beam port; and a second radiation unit configured to expand and reduce a beam size of part of a remainder of the laser beam received from the beam transmission unit through the slot mirror of the first radiation unit and simultaneously switch a direction of the part of the remainder of the laser beam within the housing, thus forming a focus in a second welding unit through the second beam port.

The laser welder may further include blower nozzles installed in the respective outsides of the first and the second beam ports and configured to spray air in order to remove spatters.

Furthermore, the beam transmission unit may include a first reflection mirror configured to send the laser beam to one side in a horizontal direction by reflecting the laser beam vertically received from the optical fiber; a first concave lens configured to expand a beam size of the laser beam while transmitting the laser beam received from the first reflection mirror; and a second reflection mirror configured to send the laser beam, expanded by the first concave lens, to the other side in a horizontal direction by reflecting the expanded laser beam toward the first radiation unit.

Furthermore, the first radiation unit may include a slot mirror configured to send part of the laser beam horizontally received from the beam transmission unit by reflecting part of the laser beam in a vertical and downward direction and send part of the laser beam to the second radiation unit through a penetration hole formed at a center of the slot mirror; a first convex lens configured to reduce a beam size of the laser beam reflected by the slot mirror in the vertical and downward direction while transmitting the reflected laser beam; a first rotation mirror configured to send the laser beam reduced by the first convex lens in a horizontal direction by reflecting the reduced laser beam; and a second rotation mirror configured to radiate the laser beam, received from the first reflection mirror, to the first welding unit through the first beam port while switching a direction of the received laser beam.

Furthermore, a penetration hole may be formed at the center of the slot mirror so that part of the laser beam passes through the penetration hole, and the remainder of the slot mirror may become a reflection surface.

Furthermore, the second radiation unit may include a second concave lens configured to expand a beam size of the laser beam received from the beam transmission unit through the slot mirror of the first radiation unit while transmitting the received laser beam; a third reflection mirror configured to reflect and send the laser beam, expanded by the first concave lens, in a vertical and downward direction; a second convex lens configured to reduce a beam size of the laser beam, reflected by the third reflection mirror in the vertical and downward direction, while transmitting the reflected laser beam; a third rotation mirror configured to reflect and send the laser beam, reduced by the second convex lens, in a horizontal direction; and a fourth rotation mirror configured to radiate the laser beam, received from the third reflection mirror, to the second welding unit through the second beam port while switching a direction of the received laser beam.

In accordance with various aspects of the present invention, use efficiency can be increased because multiple welding tasks can be performed by splitting a laser beam through the slot mirror within the housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a conventional laser welder.

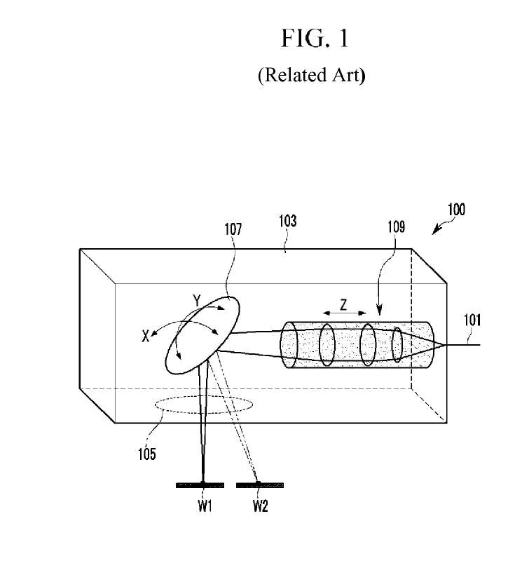

FIG. 2 is a perspective view of an exemplary laser welder in accordance with the present invention.

FIG. 3 is a schematic diagram of the laser welder of FIG. 2.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The size and thickness of each of elements shown in the drawings are randomly illustrated for convenience of description and thus the present invention is not limited to those shown in the drawings. In the drawings, a thickness is enlarged in order to clearly represent several parts and areas.

Furthermore, in the following detailed description, terms denoting the names of elements, such as the first and the second, are provided to distinguish the elements from each other because the elements have the same construction, and the elements are not limited to corresponding order in the following description.

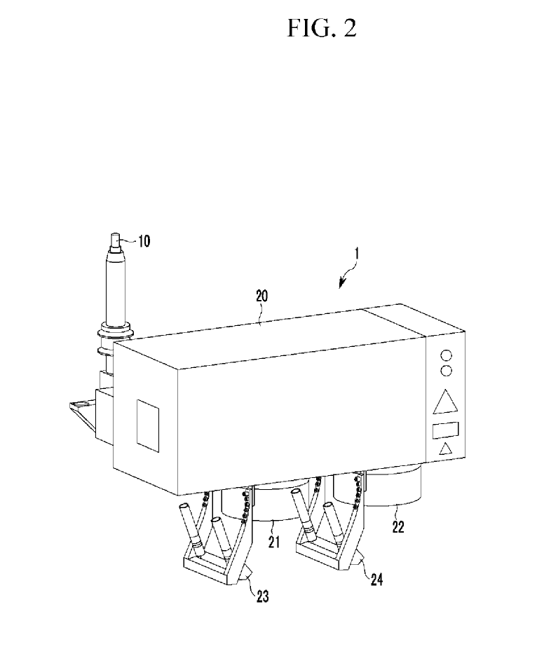

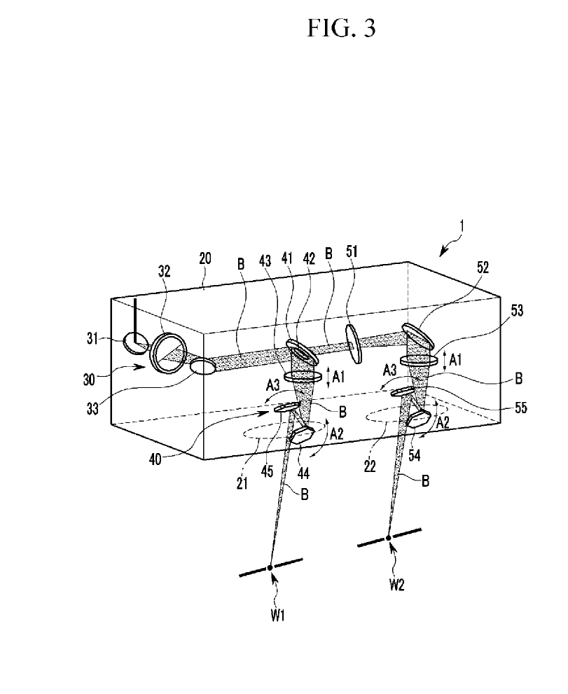

FIG. 2 is a perspective view of a laser welder in accordance with various embodiments of the present invention, and FIG. 3 is a schematic diagram of the laser welder in accordance with various embodiments of the present invention.

Referring to FIGS. 2 and 3, the laser welder 1 in accordance with various embodiments of the present invention is configured to form focuses in a first welding unit W1 and a second welding unit W1 at the same time by controlling a focus and direction of a laser beam B received from a laser oscillator through optical fiber 10 and radiating the controlled laser beam B to the first welding unit W1 and the second welding unit W1.

That is, the laser welder 1 includes a housing 20 configured to have first and second beam ports 21 and 22 formed therein, a beam transmission unit 30 configured to expand the size of the laser beam B and send the laser beam B having an expanded size, a first radiation unit 40 configured to form a focus in the first welding unit W1, and a second radiation unit 50 configured to form a focus in the second welding unit W2.

The first beam port 21 and the second beam port 22 are formed in the lower part of the housing 20. Blower nozzles 23 and 24 for spraying air in order to remove spatters occurring when a welding task is performed are installed in the respective outsides of the first beam port 21 and the second beam port 22.

The beam transmission unit 30 includes a first reflection mirror 31, a first concave lens 32, and a second reflection mirror 33. The beam transmission unit 30 expands the beam size of the laser beam B transmitted through the optical fiber 10 within the housing 20 and simultaneously switches the direction of the laser beam B to the first radiation unit 40.

That is, the first reflection mirror 31 reflects the laser beam B vertically transmitted by the optical fiber 10 and then sends the laser beam B to the first concave lens 32.

The first concave lens 32 expands the beam size of the laser beam B while transmitting the laser beam B transmitted by the first reflection mirror 31 and sends the laser beam B having an expanded beam size to the second reflection mirror 33.

The second reflection mirror 33 horizontally reflects and sends the laser beam B, expanded by the first concave lens 32, toward the first radiation unit 40.

Meanwhile, the first radiation unit 40 includes a slot mirror 41, a first convex lens 43, a first rotation mirror 44, and a second rotation mirror 45.

The first radiation unit 40 switches the direction of the laser beam B by reflecting part of the laser beam B, received from the beam transmission unit 30, using the slot mirror 41 within the housing 20 and simultaneously reduces the beam size of the laser beam B, thus forming a focus in the first welding unit W1 through the first beam port 21.

That is, a penetration hole 42 is formed at the center of the slot mirror 41 so that part of the laser beam B passes through the penetration hole 42, and the remainder of the slot mirror 41 becomes a reflection surface.

Furthermore, the slot mirror 41 sends part of the laser beam B, horizontally received from the beam transmission unit 30, to the first convex lens 43 by reflecting part of the laser beam B in a vertical and downward direction and sends part of the remainder of the laser beam B to the second radiation unit 50 through the penetration hole 42.

The first convex lens 43 reduces the beam size of the laser beam B reflected by the slot mirror 41 in the vertical and downward direction while transmitting the laser beam B and sends the reduced laser beam B to the first rotation mirror 44.

The first rotation mirror 44 sends the laser beam B reduced by the first convex lens 43 to the second rotation mirror 45 by reflecting the reduced laser beam B in a horizontal direction.

The second rotation mirror 45 switches the direction of the laser beam B received from the first rotation mirror 44 and then radiates the laser beam B to the first welding unit W1 through the first beam port 21.

Meanwhile, the second radiation unit 50 includes a second concave lens 51, a third reflection mirror 52, a second convex lens 53, a third rotation mirror 54, and a fourth rotation mirror 55.

The second radiation unit 50 expands and reduces the beam size of part of the remainder of the laser beam B transmitted by the beam transmission unit 30 through the slot mirror 41 of the first radiation unit 40 within the housing 20.

At the same time, the second radiation unit 50 switches the direction of part of the remainder of the laser beam B through the second beam port 22 and forms a focus in the second welding unit W2.

That is, the second concave lens 51 expands the beam size of the laser beam B, transmitted by the beam transmission unit 30 through the slot mirror 41 of the first radiation unit 40, toward the third reflection mirror 52 while transmitting the laser beam B.

The third reflection mirror 52 sends the laser beam B, expanded by the second concave lens 51, to the second concave lens 53 by reflecting the expanded laser beam B in a vertical and downward direction.

The second convex lens 53 reduces the beam size of the laser beam B reflected by the third reflection mirror 52 in the vertical and downward direction while transmitting the reflected laser beam B and sends the reduced laser beam B to the third rotation mirror 54.

The third rotation mirror 54 sends the laser beam B reduced by the second convex lens 53 to the fourth rotation mirror 55 by reflecting the reduced laser beam B in a horizontal direction.

The fourth rotation mirror 55 radiates the laser beam B, received from the third rotation mirror 54, to the second welding unit W2 through the second beam port 22 while switching a direction of the laser beam B.

The laser welder 1 in accordance with various embodiments of the present invention switches the direction of the laser beam B transmitted through the optical fiber 10 and sends the laser beam B having a switched direction to the first radiation unit 40 through the beam transmission unit 30.

Part of the laser beam B transmitted to the first radiation unit 40 is radiated to the first welding unit W1 through the first convex lens 43 and the first and the second rotation mirrors 44 and 45, thus forming a focus in the first welding unit W1.

Here, the direction of the laser beam B transmitted to the first radiation unit is switched by the reflection surface of the slot mirror 41, so part of the laser beam B is transmitted to the first radiation unit 40 and part of the remainder of the laser beam B is transmitted to the second radiation unit 50 through the penetration hole 42.

The laser beam B transmitted to the second radiation unit 50 is radiated to the second welding unit W1 through the second concave lens 51, the third reflection mirror 52, the second convex lens 53, and the third and the fourth rotation mirrors 54 and 55.

Accordingly, the laser welder 1 in accordance with various embodiments of the present invention can split the laser beam B into the first radiation unit 40 and the second radiation unit 50 through the slot mirror 41 installed within the housing 20 and performs multiple welding tasks at the same time within one laser welder 1. Accordingly, task efficiency and laser use efficiency can be increased.

Meanwhile, the first and the second convex lenses 43 and 53 are installed so that they can move in an arrow direction A1, that is, in up and down directions, and the first and the second rotation mirrors 44 and 45 and the third and the fourth rotation mirrors 54 and 55 are installed so that they can be rotated in arrow directions A2 and A3, that is, front and rear. Accordingly, the focuses and directions of the first and the second welding units W1 and W2 can be controlled.

For convenience in explanation and accurate definition in the appended claims, the terms lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A laser welder for controlling a focus and direction of a laser beam received from a laser oscillator through an optical fiber and radiating a controlled laser beam, the laser welder comprising:
a housing including a first beam port and a second beam port formed in a lower part of the housing;
a beam transmission unit to expand a beam size of the laser beam received through the optical fiber, simultaneously switch the direction of the laser beam, and send the laser beam within the housing;
a first radiation unit to switch a direction of the laser beam by reflecting a portion of the laser beam received from the beam transmission unit through a slotted mirror and simultaneously reduce the beam size of the laser beam within the housing, thus forming a focus in a first welding unit through the first beam port; and
a second radiation unit to expand and reduce a beam size of a remainder portion of the laser beam received from the beam transmission unit through the slotted mirror of the first radiation unit and simultaneously switch a direction of the remainder portion of the laser beam within the housing, thus forming a focus in a second welding unit through the second beam port.

2. The laser welder of claim 1, further comprising blower nozzles adjacent the first and the second beam ports and to blow air in order to remove spatters.

3. The laser welder of claim 1, wherein the beam transmission unit comprises:
a first reflection mirror to send the laser beam to a first side in a horizontal direction by reflecting the laser beam vertically received from the optical fiber;
a first concave lens to expand a beam size of the laser beam while transmitting the laser beam received from the first reflection mirror; and
a second reflection mirror to send the laser beam, expanded by the first concave lens, to a second side in a horizontal direction by reflecting the expanded laser beam toward the first radiation unit.

4. The laser welder of claim 1, wherein the first radiation unit comprises:
a slotted mirror to send the portion of the laser beam horizontally received from the beam transmission unit by reflecting a first portion of the laser beam in a vertical and downward direction and send a second portion of the laser beam to the second radiation unit through a penetration hole formed at a center of the slotted mirror;
a first convex lens configured to reduce a beam size of the laser beam reflected by the slotted mirror in the vertical and downward direction while transmitting the reflected laser beam;
a first rotation mirror configured to send the laser beam reduced by the first convex lens in a horizontal direction by reflecting the reduced laser beam; and
a second rotation mirror configured to radiate the laser beam, received from the first reflection mirror, to the first welding unit through the first beam port while switching a direction of the received laser beam.

5. The laser welder of claim 1, wherein a penetration hole is formed at a center of the slotted mirror so that the portion of the laser beam passes through the penetration hole, and a remainder of the slotted mirror is a reflection surface.

6. The laser welder of claim 1, wherein the second radiation unit comprises:
a second concave lens configured to expand a beam size of the laser beam received from the beam transmission unit through the slotted mirror of the first radiation unit while transmitting the received laser beam;
a third reflection mirror configured to reflect and send the laser beam, expanded by the first concave lens, in a vertical and downward direction;
a second convex lens configured to reduce a beam size of the laser beam, reflected by the third reflection mirror in the vertical and downward direction, while transmitting the reflected laser beam;
a third rotation mirror configured to reflect and send the laser beam, reduced by the second convex lens, in a horizontal direction; and
a fourth rotation mirror configured to radiate the laser beam, received from the third reflection mirror, to the second welding unit through the second beam port while switching a direction of the received laser beam.
